(19) United States
(12) Patent Application Publication
(10) Pub. No.: US 2014/0136196 A1
(43) Pub. Date: May 15, 2014

(54) SYSTEM AND METHOD FOR POSTING MESSAGE BY AUDIO SIGNAL

(71) Applicant: INSTITUTE FOR INFORMATION INDUSTRY, Taipei (TW)

(72) Inventors: Chen-Ming WU, Chiayi City (TW); Ping-Che YANG, Kaohsiung City (TW); Tsun KU, Taipei City (TW); Wen-Tai HSIEH, Taipei City (TW); Hung-Sheng CHIU, New Taipei City (TW)

(73) Assignee: INSTITUTE FOR INFORMATION INDUSTRY, Taipei (TW)

(21) Appl. No.: 13/898,571

(22) Filed: May 21, 2013

(30) Foreign Application Priority Data
Nov. 9, 2012 (TW) 101141725

(51) Int. Cl. G10L 15/26

(52) U.S. Cl. CPC G10L 15/265; G10L 15/26
USPC 704/235

(57) ABSTRACT

A system for posting a message by an audio signal is provided. The system has: a communication unit used to connect the system to a communications network; an audio receiving unit used to receive a first audio signal; a display unit; and a processing unit, connected to the communication unit, the audio receiving unit and the display unit, used to recognize the first audio signal to generate a first string, determine a target object from a display screen displayed on the display unit according to the first string, and automatically generate a message corresponding to the target object, and post the message on a social network through the communication unit.

### CROSS REFERENCE TO RELATED APPLICATIONS

This Application claims priority of Taiwan Patent Application No. 101141725, filed on Nov. 9, 2012, the entirety of which is incorporated by reference herein.

### BACKGROUND OF THE INVENTION

1. Field of the Invention

The present invention relates to a system and method for automatically posting a messages by an audio signal, and in particular, relates to a system and method capable of receiving and analyzing an audio signal to generate a string, and automatically posting a message to a social network by generating the message corresponding to a target object, which is determined from a display screen according to the generated string.

2. Description of the Related Art

With the advances in different technologies, electronic devices, such as smart phones, tablet PCs, laptops, personal computers, have become more and more popular. In addition, many users often post messages on social websites or social networks (e.g. Facebook, Google+). For example, after logging onto a social website, the user may post messages corresponding to products, stores, objects, and events. When the electronic devices are used for word-of-mouth information on social websites, the user may post messages or check-in on a community page of a store or a product on the social website. However, the user usually needs to perform a lot of steps in advance before posting messages, such as logging onto a social website, preparing the messages or data (e.g. pictures, photos, or comments) to be posted, and uploading the messages to the social website. It is very inconvenient for the user to operate such a complicated procedure.

Currently, logon data of a user in social websites can be preset in many electronic devices in order to automatically logon onto the social websites and quickly posting messages. However, when a user wants to post a message on a social website, the user still has to use the interface of the social website to select photos/images or input texts, to post the message on the “wall” of the user in the social website (e.g. Facebook). But, the user can not post a message automatically on a social website by an audio signal from conventional electronic devices.

Posting of the message is based on a “landmark” or a “location” when the user wants to post a message or check-in on the community page of a store or a product on a social website. For example, corresponding information and the geographical location of a store can be preset on the social website by the store terminal. When the user reaches the geographical location of the store with his electronic device, the user's geographical location can be confirmed by a positioning mechanism in the electronic device. Accordingly, the user may check-in on the social website at the geographical location of the store, and the visitor history of the user or the consumption records at the store will be public on the social website. The geographical location of the user is primarily used to check-in on the social website in the conventional way, but the user can not check-in on the social website via an audio signal. In addition, the electronic device can not post a message associated with the store when the user has not reached the geographical location of the store yet.

In a conventional procedure, many steps, such as logging onto a social website, using user interfaces of the social website, are required for posting a message or check-in on the social website, and thus the conventional procedure is not intuitive and convenient for a user. When a user wants to automatically post a message on a social website by using a smart phone or a tablet PC with lower computation resources or a smaller display screen, it is very inconvenient for the user to use the interfaces of the social website, select photos/images manually, and input texts. Accordingly, there is a demand for a system and method capable of automatically posting a message in a more convenient and effective way, such as using an audio signal, thereby automatically posting the message intuitively and conveniently for the user.

### BRIEF SUMMARY OF THE INVENTION

A detailed description is given in the following embodiments with reference to the accompanying drawings.

In an exemplary embodiment, a system for posting a message by an audio signal is provided. The system comprises: a communication unit used to connect the system to a communications network; an audio receiving unit used to receive a first audio signal; a display unit; and a processing unit, connected to the communication unit, the audio receiving unit and the display unit, and used to recognize the first audio signal to generate a first string, determine a target object from a display screen displayed on the display unit according to the first string, and automatically generate a message corresponding to the target object, and post the message on a social network through the communication unit.

In another exemplary embodiment, a method for posting a message by an audio signal is provided. The method comprises the following steps of: connecting to a communications network via a communication unit; receiving a first audio signal via an audio receiving unit; recognizing the first audio signal to generate a first string via a processing unit; determining a target object according to the first string and a display screen displayed on a display unit via the processing unit; automatically generating a message corresponding to the target object via the processing unit; and posting the message on a social network via the communication unit.

### BRIEF DESCRIPTION OF THE DRAWINGS

The present invention can be more fully understood by reading the subsequent detailed description and examples with references made to the accompanying drawings, wherein:

FIG. 1 is a schematic diagram of a system 100 for automatically posting a message by using an audio signal according to an embodiment of the invention;

FIGS. 2A and 2B are diagrams illustrating the system for automatically posting a message by using an audio signal according to different embodiments of the invention; and

FIG. 3 is a flow chart illustrating the method for posting a message by an audio signal according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

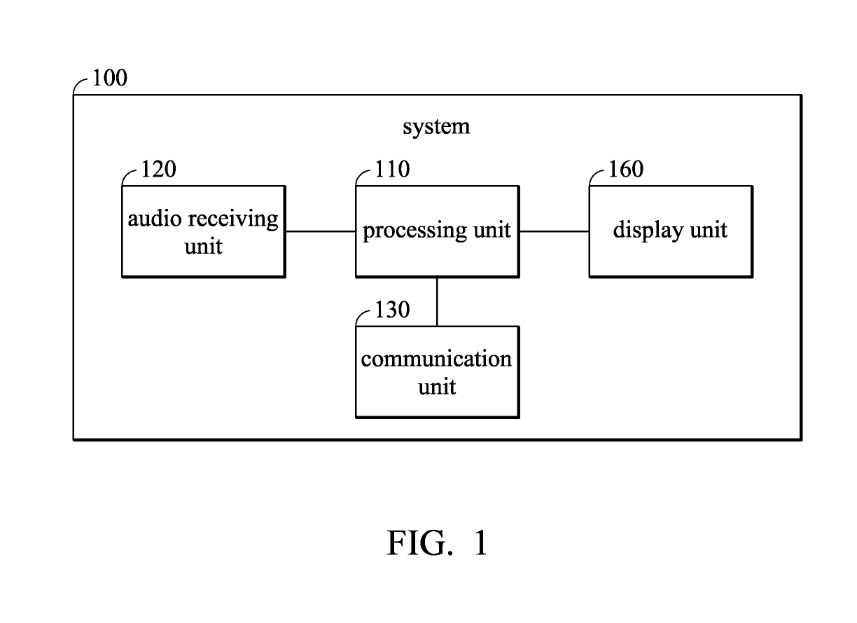

FIG. 1 is a schematic diagram of a system 100 for automatically posting a message by using an audio signal according to an embodiment of the invention. The system 100 at least comprises a processing unit 110, an audio receiving unit 120, a communication unit, and a display unit 160. The aforementioned components can be implemented in the same electronic device, such as a smart phone, a tablet PC, a laptop, or a personal computer. In addition, the aforementioned components can be implemented in different electronic devices, which connect to each other by cables (e.g. RS232 interface bus) or wired/wireless communications networks. For example, the processing unit 110 can be implemented in a remote server, and the audio receiving unit 120, the communications 130 and the display unit 160 can be implemented in a smart phone, but the invention is not limited thereto. Details of functionality of aforementioned components will be described in the following sections.

The audio receiving unit 120 is used to receive an audio signal. For example, the audio receiving unit 120 may be a microphone, a sound receiver, a sound collector, or other transformation device capable of converting audio signals to electrical signals, but the invention is not limited thereto. The communication unit 130 may be a network interface, which may be a wired or wireless network interface supporting TCP/IP, Wifi, or 802.11x protocols, or physical components for connecting to communications networks, such as a network adapter, a GPRS module, a 3G module/network adapter, a 3.5G module/network adapter, or a Bluetooth module, but the invention is not limited thereto. The display unit 160 may be a monitor or a display on the market for display information or pictures, such as a CRT, LCD, PDP, or LED display, but the invention is not limited thereto.

The processing unit 110, which is connected to the communication unit 130, the audio receiving unit 120 and the display unit 160, is primarily used to recognize a first audio signal received by the audio receiving unit 120 to generate a first string, determine a target object from the display screen displayed on the display unit 160 according to the first string, and automatically generate a message corresponding to the target object, and post the message to a social network or web pages through the communication unit 130. For example, the processing unit 110 may post the message corresponding to the target object on the “wall” of the social network or web pages (e.g. Facebook) with the user's account information, or post the message or check-in with the user's account information on the store/community pages. The message posted on the website may be a text, a picture, a photo, an image, a sound signal, or a hyperlink corresponding to the target object, or any two in combination. The target object, for example, may be a name, a picture, or a sound signal, a text or image information for indicating an object, which corresponds to a product, a store, an enterprise, a person or an event.

In another embodiment, the processing unit 110 may further comprise an audio detection module (not shown in FIG. 1) used to recognize the audio signal received by the audio receiving unit 120, and convert the audio signal into texts (i.e. using audio-to-text techniques). Then, the processing unit 110 may use well-known techniques for word segmentation and semantic analysis according to the converted texts to generate a first string. Further, well-known audio recognition techniques (e.g. pitch, tune, frequency, or volume of the audio signal) can also be used in the audio detection module to analyze the audio signal for determining the emotional tendency of the audio signal. In addition, the processing unit 110 may also use well-known semantic recognition techniques according to the converted texts to determine the emotional tendency of the user who sent the audio signal. The determined emotional tendency can be used to start the following processes by the processing unit 110 for generating the first string, determining the target object, generating the message, and posting the message to a social network automatically. For example, before generating the first string, the audio receiving unit 120 may consistently receive audio signals from the user, and the processing unit 110 and/or the audio detection module may also consistently determine the emotional tendency of the user. When the determined emotional tendency represents that the user is interested in something or intends to post a message, the processing unit 110 may start to execute the processes for generating the first string, determining the target object, generating the message, and automatically posting the message to a social network. It should be noted that the functions of the audio detection module can be implemented by the processing unit 110, or other specific logic circuits independent from the processing unit 110. In the following embodiments, the functions of the audio detection module are implemented by the processing unit 110 for description.

In other embodiments, before the processing unit 110 generates the first string, the processing unit 110 may start the following processes by receiving a specific sensor signal, a specific operation command, or a specific speech for generating the first string, determining the target object, generating the message, and automatically posting the message to a social network.

In another embodiment, when the display screen is a web page, the processing unit 110 may further analyze the syntax of the web page (i.e. web page syntax), thereby obtaining the boundary of the current display screen (e.g. the currently screen of the web page displayed on the display unit 160) for the web page, and recognize multiple objects and corresponding information from the web page by using any one of the following techniques of tag analysis of the web page, snippet information matching, pattern recognition, hyperlink and title matching, and optical character recognition. Specifically, the processing unit 110 may determine at least one candidate object according to the generated first string and the display screen, and determine the target object according to the at least one candidate object. For example, a display screen may usually comprise multiple objects. The processing unit 110 may recognize multiple objects from the display screen, and compare the first string with each object and/or corresponding information, thereby determining at least one candidate object which matches or is highly correlated to the first string from the objects. In some embodiments, the processing unit 110 may provide a user interface for selecting one of the candidate objects. In other embodiments, the processing unit 110 may further search for corresponding data of each candidate item from a network or a database, and determine whether each candidate item matches or is highly correlated to the first string, thereby determining one of the candidate objects as the target object.

In another embodiment, the system 100 may comprise a database (not shown in FIG. 1) used to store a plurality of identity reference images of multiple objects, wherein each identity reference image may have a corresponding name, description information or other related information. When the processing unit 110 is determining candidate objects, the processing unit 110 may capture the display screen to generate an image file, and analyze the image file to generate at least one object images. Then, the processing unit 110 may match the analyzed object images with the identity reference images in the database, thereby generating a matching result. For example, the processing unit 110 may retrieve object images, which have similarity larger than a threshold value with any one identity reference image in the database, as candidate objects from the image file.

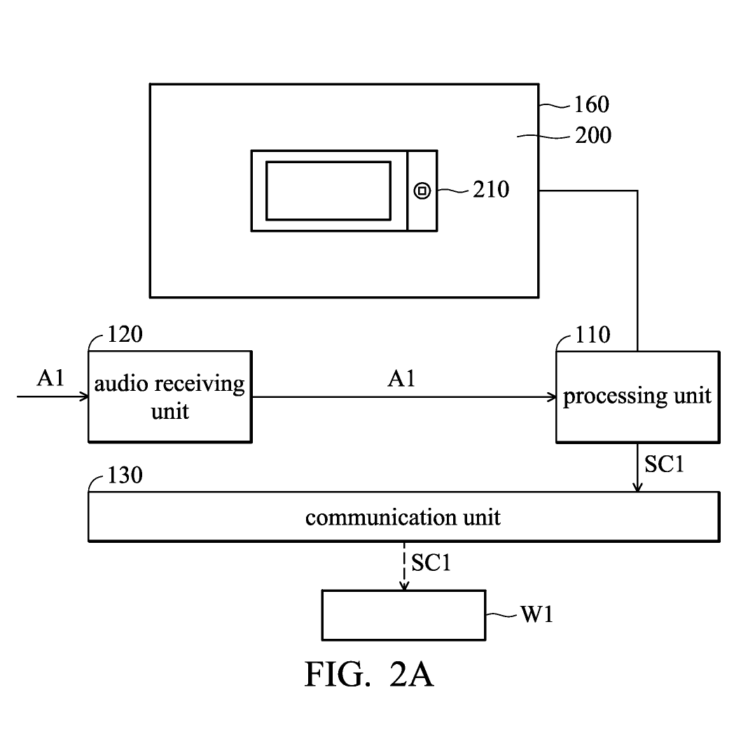

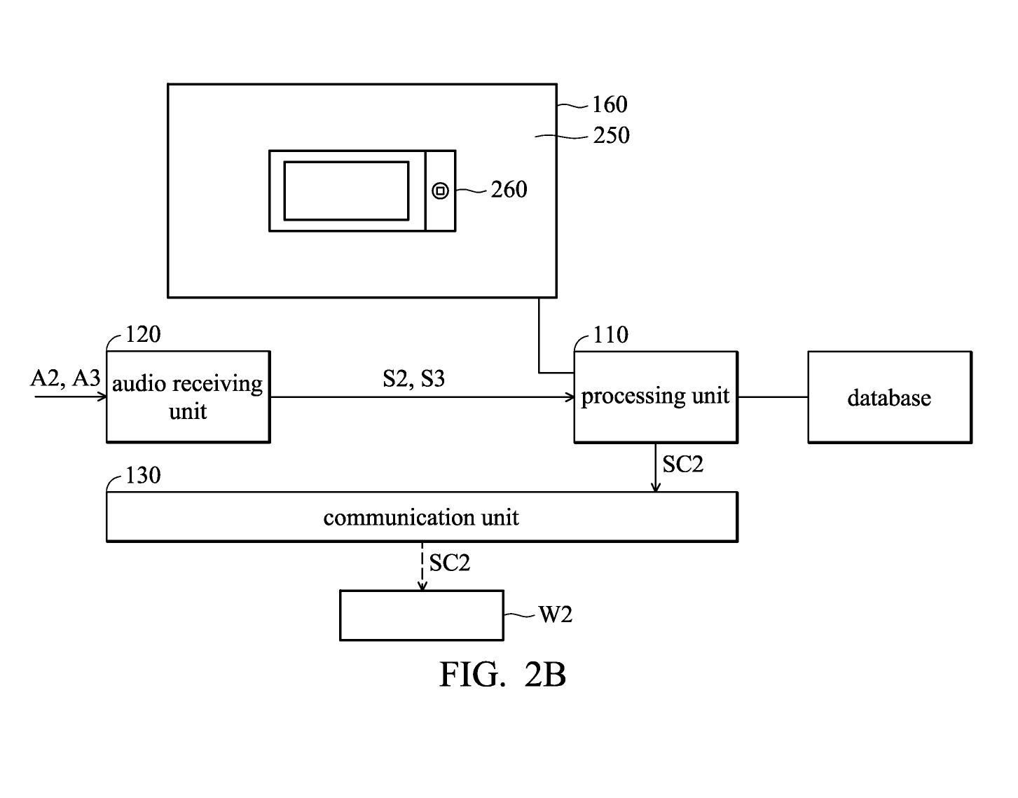

FIGS. 2A and 2B are diagrams illustrating the system for automatically posting a message by using an audio signal according to different embodiments of the invention. In an embodiment, as illustrated in FIG. 2A, there are some objects or products (e.g. object 210), which the user is interested in, on a web page 200 displayed by the display unit 160 of the system 100 when a user views the web page 200. An audio signal A1 can be inputted via the audio receiving unit 120 for showing user's interest. When the processing unit 110 has received the audio signal A1 inputted by the user, the processing unit 110 may recognize the received audio signal A1 and convert the audio signal A1 to a corresponding string S1. For example, the processing unit 110 may use well-known speech recognition techniques (e.g. analyzing the pitch, tune, frequency, and volume of the audio signal) to analyze the audio signal A1, thereby determining the emotional tendency of the user from the audio signal A1. In addition, the processing unit 110 may use well-known semantic recognition techniques according to the string S1, thereby determining the emotional tendency of the user from the audio signal A1. When the processing unit 110 determines that the emotional tendency of the user represented by the audio signal A1 matches a certain predetermined criterion (e.g. presetting criteria), the processing unit 110 may determine a target object from the string S1 and the web page 200 (i.e. the display screen), and automatically generate a message SC1 corresponding to the string S1. Then, the processing unit 110 may automatically post the message SC1 onto a social website W1 with the user's account information through the communication unit 130. It should be noted that the message generated by the processing unit 110 may be a text, a picture, a sound signal, a hyperlink or any combination thereof corresponding to the target object. Taking Facebook for example, the message SC1 may comprise a message posted on the wall of the user's own social account, and a check-in message or a message posted on the store/community page. In addition, the message SC1 may be directly posted after being generated by the processing unit 110. The user may also modify/edit texts or pictures within the message SC1 before the processing unit 110 posts the modified/edited message. For example, the system 100 may further comprise a storage unit used to store the user accounts, passwords, and corresponding community information (e.g. community page in Facebook) in different social communities. When the user wants to post a message on a social network (or a social website) via the system 100, the processing unit 110 may retrieve the corresponding user account and password, thereby posting the message on the corresponding social network (or the social website).

In another embodiment, as illustrated in FIG. 2B, there are some objects or products (e.g. object 210), which the user is interested in, on a web page 200 displayed by the display unit 160 of the system 100 when a user views the web page 200. The function for posting a message by an audio signal can be activated by activating an application (e.g. a message posting application) of the invention, receiving a sensor signal from a mobile device, or manipulating a user interface. Then, the user may input an audio signal A2 through the audio receiving unit 120. When the processing unit 110 receives the audio signal A2 inputted by the user, the processing unit 110 may recognize the received audio signal A2, convert the received audio signal A2 to a corresponding string S2, and determine a target object according to the converted string S2 and the display screen. As described in the aforementioned embodiments, the database of the system 100 may store a plurality of identity reference images of multiple objects. The processing unit 110 may capture the display screen to generate an image file, and analyze the image file to generate at least one object images. Then, the processing unit 110 may match the analyzed object images with the identity reference images in the database to generate a matching result, thereby retrieving at least one candidate object having an object image matching or being similar to any identity reference image in the database. In other words, object having object images matching or similar to any identity reference image stored in the database, may be regarded as the candidate object. Then, the processing unit 110 may further determine a target object from the at least one candidate object (i.e. the details will be described later), and automatically generate a message SC2 corresponding to the target object. The processing unit 110 may further automatically post the message SC2 on a social website W2 with the user's account information through the communication unit 130. For example, after determining the target object, the processing unit 110 may retrieve identity reference images which match or are similar to the object image of the target object. In addition, corresponding texts and pictures of each identity reference image can be pre-stored in the database, and the processing unit 110 may set the corresponding texts and pictures of the retrieved identity reference image as a portion of the message SC2.

In some other embodiments, the audio signal sent by the user may comprise information of the target object. After the processing unit 110 converts the audio signal into texts or strings, the processing unit 110 may determine whether a name (e.g. a product name, a store name, or an enterprise name) of the target object is included in the string. Accordingly, when the processing unit 110 determines there is a name of the target object in the string, the processing unit 110 may retrieve the corresponding target object from the display screen according to the name of the target object, and generate a message corresponding to the target object. Then, the processing unit 110 may further post the generated message to a social network through the communication unit 130. Alternatively, when the processing unit 110 determines that there is a name of the target object in the string, the processing unit 110 may automatically search for corresponding data associated with the name of the target object from the network or the database, thereby generating the message corresponding to the target object. However, when the processing unit 110 has converted the audio signal into texts or a string and the processing unit 110 is unable to find a name of the target object, the processing unit 110 may further recognize possible objects from the display screen (e.g. the screen of the web page currently viewed by the user). For example, the processing unit 110 may determine candidate objects from the pictures, the title, or the text description of the web page, and determine a target object from the candidate objects. In addition, the processing unit 110 may search for corresponding information of the target object from a communications network through the communication unit 130, thereby generating the message.

When the display screen is a web page, the processing unit 110 may use techniques, such as tag analysis of the web page, snippet information matching, pattern recognition, hyperlink and title matching, and optical character recognition, to determine a target object from the web page currently viewed by the user. For example, a web page is generally written by HTML language or Java scripts, and the processing unit 110 may analyze the syntax of the HTML and Java script source codes of the web page, thereby retrieving positions of each picture and description information of the web page in the screen. The processing unit 110 may perform the techniques, such as tag analysis of the web page, snippet information matching, and hyperlink and/or title matching, thereby obtaining names of possible candidate objects. Then, the processing unit 110 may perform pattern recognition and/or optical character recognition to the pictures of the web page in the display screen, thereby retrieving names and types of the candidate objects and description information in the pictures. When performing pattern recognition, the processing unit 110 may match the image features of the pictures in the screen with the identity reference images in the database, thereby determining whether there are conformed candidate objects.

If there is information corresponding to only one candidate object of the web page in the screen according to the matching result generated by the processing unit 110, the processing unit 110 may directly determine the candidate object as the target object. In an embodiment, if there is at least one candidate object in the matching result generated by the processing unit 110, the processing unit 110 may provide a user interface to display the at least one candidate object (e.g. name and/or pattern of the candidate objects) on the display unit 160, so that the user may select one of the at least one candidate object as the target object. For example, the user may use a peripheral device (e.g. a mouse or a keyboard) to select one of the candidate objects as the target object on the user interface displayed on the display unit 160.

In another embodiment, if there is at least one candidate object in the matching result generated by the processing unit 110, the processing unit 110 may display the at least one candidate object (e.g. name and/or pattern of the candidate objects) on the display unit 160. Then, the audio receiving unit 120 may further receive an audio signal A3, and the audio detection module may recognize the audio signal A3 to generate a string S3. Accordingly, the processing unit 110 may determine the target object from the at least one candidate object according to the generated string S3.

It should be noted that the processing unit 110 may automatically generate a message SC2 corresponding to the target object after the target object has been determined. Then, the processing unit 110 may post the message SC2 on the social website W2 through the communication unit 130.

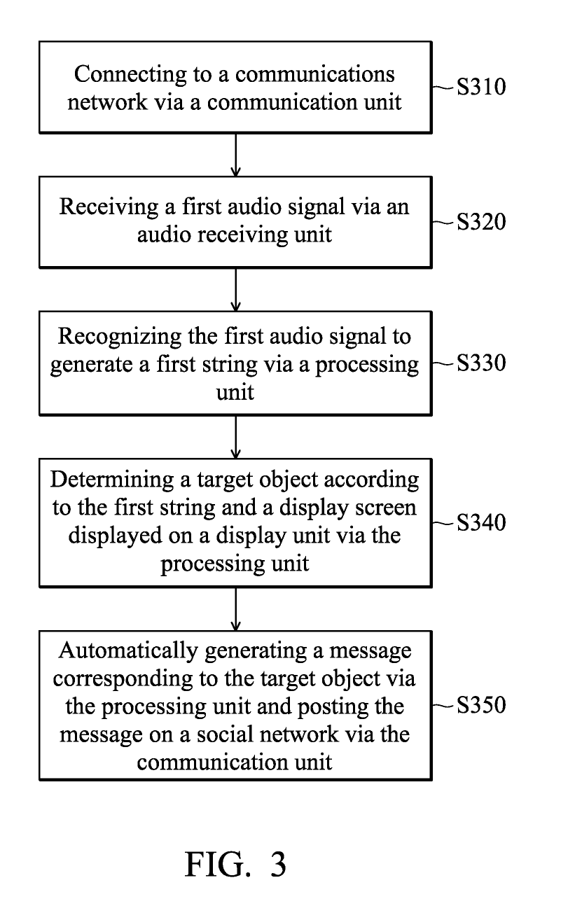

FIG. 3 is a flow chart illustrating the method for posting a message by an audio signal according to another embodiment of the invention. In step S310, the system 100 may connect to a communications network through the communication unit 130. In step S320, the system 100 may receive a first audio signal through the audio receiving unit 120. In step S330, the processing unit (e.g. executing the audio detection module) 110 may recognize the received first audio signal from the audio receiving unit 120 to generate a first string. For example, the processing unit 110 may perform well-known techniques, such as word segmentation and semantic analysis, to the converted texts generated by the processing unit 110 to generate the first string. In step S340, the processing unit 110 may determine a target object from a display screen displayed on the display unit 160 according to the first string. For example, the target object may be a name or a picture of a specific object, or other sounds, texts, or image information indicating the specific object. In step S350, the processing unit 110 may automatically generate a message corresponding to the target object, and post the message on a social network through the communication unit 130.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for posting a message by an audio signal, comprising
a communication unit used to connect the system to a communications network;
an audio receiving unit used to receive a first audio signal;
a display unit; and
a processing unit, connected to the communication unit, the audio receiving unit and the display unit, and used to recognize the first audio signal to generate a first string, determine a target object from a display screen displayed on the display unit according to the first string, and automatically generate a message corresponding to the target object, and post the message on a social network through the communication unit.

2. The system as claimed in claim 1, wherein the message is at least one of a text, a picture, a sound signal and a hyperlink corresponding to the target object, and the message corresponds to a user in the social network, wherein posting the message to the social network indicates that the processing unit transmitted the message to the social network, thereby automatically posting the message corresponding to the user.

3. The system as claimed in claim 1, wherein the processing unit further determines at least one candidate object according to the first string and the display screen, and determines the target object according to the at least one candidate object.

4. The system as claimed in claim 3, wherein the display screen is a web page, and the processing unit further analyzes a web page syntax of the web page, thereby obtaining a boundary of the display screen for the web page,
wherein the processing unit determines the at least one candidate object from the web page by at least one of tag analysis of the web page, snippet information matching, hyperlink and title matching, and optical character recognition.

5. The system as claimed in claim 3, wherein the system further comprises a database used to store a plurality of identity reference images, wherein the processing unit further generates an image file from the display screen, analyzes the image file to generate at least one object image, generates a matching result by matching the at least one object image with the plurality of identity reference images in the database, and determines the at least one candidate object according to the matching result.

6. The system as claimed in claim 3, wherein the processing unit further provides a user interface to display the at least one candidate object on the display unit, so that the user uses the user interface to select one of the at least one candidate object as the target object.

7. The system as claimed in claim 3, wherein the processing unit further displays the at least one candidate object on the display unit, receives a second audio signal, recognizes the second audio signal to generate a second string, and determines the target object from the at least one candidate object according to the second string.

8. The system as claimed in claim 1, wherein the processing unit further searches for corresponding information of the target object through the communications network and the communication unit according to the target object, thereby generating the message.

9. A method for posting a message by an audio signal, comprising:
connecting to a communications network via a communication unit;
receiving a first audio signal via an audio receiving unit;
recognizing the first audio signal to generate a first string via a processing unit;
determining a target object according to the first string and a display screen displayed on a display unit via the processing unit;
automatically generating a message corresponding to the target object via the processing unit; and
posting the message on a social network via the communication unit.

10. The method as claimed in claim 9, wherein the message is at least one of a text, a picture, a sound signal and a hyperlink corresponding to the target object, and the message corresponds to a user in the social network, wherein the step of posting the message to the social network indicates the message has been transmitted to the social network, thereby automatically posting the message corresponding to the user.

11. The method as claimed in claim 9, further comprising:
determining at least one candidate object according to the first string and the display screen via the processing unit; and
determining the target object according to the at least one candidate object via the processing unit.

12. The method as claimed in claim 11, wherein the display screen is a web page, and the method further comprises:
analyzing a web page syntax of the web page via the processing unit, thereby obtaining a boundary of the display screen for the webpage; and
determining the at least one candidate object from the web page by at least one of tag analysis of the web page, snippet information matching, hyperlink and title matching, and optical character recognition, via the processing unit, thereby determining the at least one candidate object from the web page.

13. The method as claimed in claim 11, further comprising:
storing a plurality of identity reference images via a database, wherein the step of determining the at least one candidate object via the processing unit indicates generating an image file from the display screen, analyzing the image file to generate at least one object image, generating a matching result by matching the at least one object image with the plurality of identity reference images in the database, and determining the at least one candidate object according to the matching result.

14. The method as claimed in claim 11, further comprising:
providing a user interface via the processing unit, thereby displaying the at least one candidate object on the display unit, so that a user uses the user interface to select one of the at least one candidate object as the target object.

15. The method as claimed in claim 11, further comprising:
utilizing the processing unit to perform the steps of:
displaying the at least one candidate object on the display unit;
receiving a second audio signal;
recognizing the second audio signal to generate a second string; and
determining the target object from the at least one candidate object according to the second string.

16. The method as claimed in claim 9, further comprising:
searching for corresponding information of the target object through the communications network and the communication unit according to the target object via the processing unit, thereby generating the message.
